(19) United States
(12) Patent Application Publication
(10) Pub. No.: US 2026/0289287 A1
(43) Pub. Date: Sep. 24, 2026

(54) ON-DEVICE CONVERSION OF MACHINE GENERATED DATA USING IDLE RESOURCES OF NEURAL PROCESSING UNITS

(71) Applicant: Dell Products L.P., Round Rock, TX (US)

(72) Inventors: RUWAN ASANKA WASALA, Limerick (IE); ONUR CELEBIOGLU, Austin, TX (US); JEANNIE FITZGERALD, Ennis (IE)

(21) Appl. No.: 19/085,618

(22) Filed: Mar. 20, 2025

(51) Int. Cl. G06N 3/063; G06N 3/045; G06N 3/096

(52) U.S. Cl. CPC G06N 3/063; G06N 3/045; G06N 3/096

(57) ABSTRACT

Methods and systems for machine generated data conversion are disclosed. Machine generated data collected from a data processing system may be converted into human readable data using idle neural processing unit (NPU) resources of the data processing system. The NPU may host a first large language model (LLM) that performs the machine generated data conversion into human interpretable data using the idle NPU resources. The human interpretable data may be further transformed into one or more prompts or responses that are presented in narrative form to a user of the data processing system.

### FIELD

Embodiments disclosed herein relate generally to use of neural processing units (NPUs). More particularly, embodiments disclosed herein relate to systems and methods for using idle resources of NPUs installed in a data processing system (e.g., a computing device) to perform conversion of machine generated data into human readable data.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components and the components of other devices may impact the performance of the computer implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with one or more embodiments.

FIG. 1B shows a block diagram illustrating a data processing system in accordance with one or more embodiments.

FIGS. 1C shows a data flow diagram in accordance with one or more embodiments.

FIG. 2A-2B show additional data interaction diagrams in accordance with one or more embodiments.

FIGS. 3A-3D show implementation examples in accordance with one or more embodiments.

FIG. 4 shows a flowchart in accordance with one or more embodiments.

FIG. 5 shows a block diagram illustrating a computing device in accordance with one or more embodiments.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

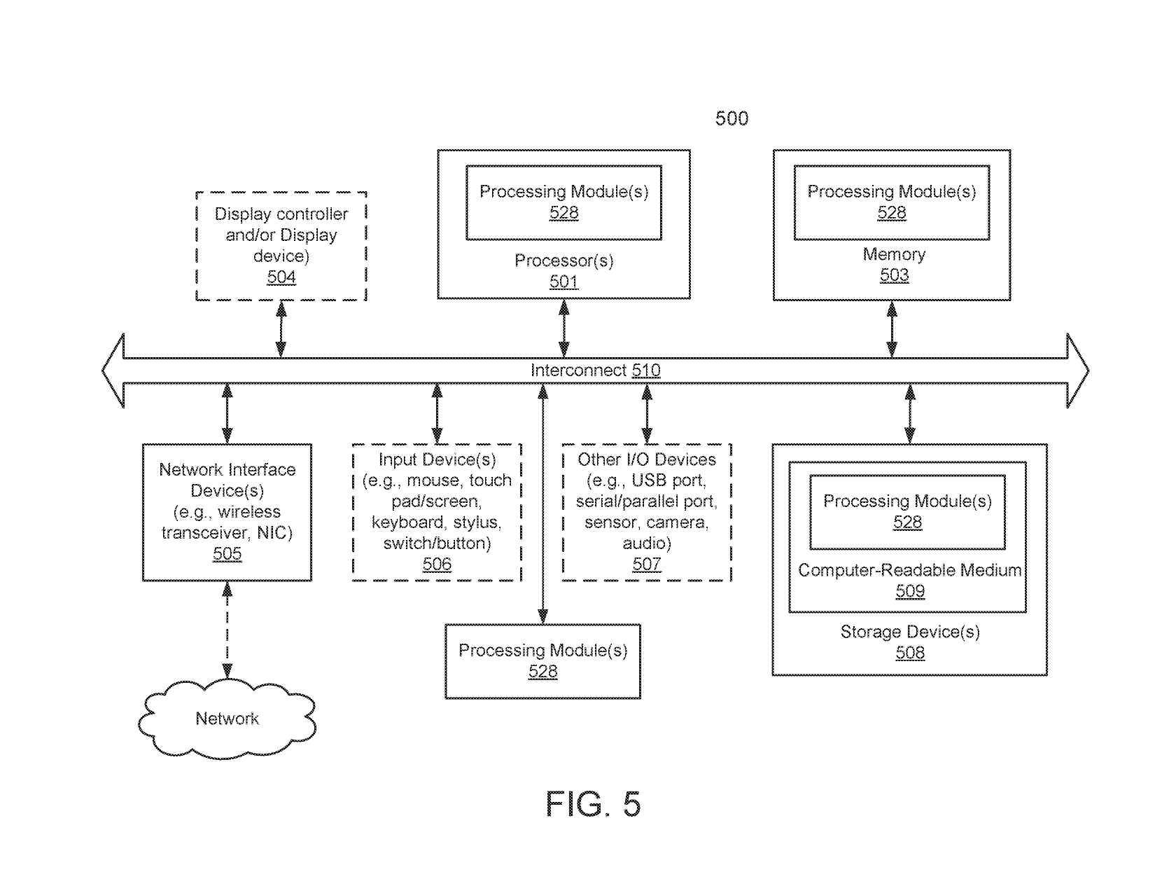

In general, embodiments disclosed herein relate to methods and systems for performing data conversion (e.g., from machine generated data to human readable data) using idle resources of one or more on-device neural processing units (NPUs) of a data processing system (e.g., computing devices, as described below in reference to FIG. 5).

As artificial intelligence (AI) based technologies continue to advance, special processing units (e.g., graphical processing units (GPUs), NPUs, or similar computer chips) dedicated for AI tasks (e.g., machine learning/AI model training, machine learning/AI model execution, or the like) are developed to ease the burden on existing computing processing units (CPUs) of data processing systems.

For example, an NPU is a dedicated processor or processing unit on a larger system on a chip (SoC) designed specifically for accelerating neural network operations and AI tasks. Unlike general-purpose CPUs and GPUs, NPUs are optimized for a data-driven parallel computing, making them highly efficient at processing massive multimedia data like videos and images and processing data for neural networks. They are particularly adept at handling AI-related tasks, such as speech recognition, background blurring in video calls, and photo or video editing processes like object detection. Additionally, NPUs are integrated circuits but they differ from single-function ASICs (Application-Specific Integrated Circuits). While ASICs are designed for a singular purpose (such as mining bitcoin), NPUs offer more complexity and flexibility, catering to the diverse demands of network computing. They achieve this through specialized programming in software or hardware, tailored to the unique requirements of neural network computations.

In some cases (e.g., in consumer based electronic cases or the like), an NPU may be integrated into the main CPU of a data processing system while in other cases (e.g., at larger data centers or more specialized industrial operations or the like), the NPU might be an entirely discrete processor (e.g., separate from any other processing units) installed on a motherboard of the data processing system.

Since NPUs are specifically designed to implement AI related tasks, an NPU of a data processing system may have more idle time than the CPU of the same data processing system. In particular, while no AI related tasks are being implemented or scheduled, the CPU may be busy executing other processes (e.g., the operating system, non-AI related applications, or the like) while the NPU sits idle. While the NPU sits idle, the computing resources of the idle NPU sits wasted.

Because NPUs are much more expensive and more difficult to obtain than CPUs and GPUs, more effective use of these NPUs is generally desired than to let these NPUs sit idle and go to waste. Thus, embodiments disclosed herein utilize such idle periods of NPUs for execution of tasks that users and/or data processing system may not need but could find helpful (e.g., helpful for the user and helpful for improving the functionalities of the data processing system).

One such task includes the conversion of machine generated data into human readable data. In particular, in an era where electronic devices (e.g., computing devices and systems) continuously generate a myriad of machine generated data in the form of raw (e.g., non-human-processed, non-human-annotated, or the like) sensor readings to complex event logs, the challenge of transforming such machine generated data into a format understandable by non-experts (e.g., regular consumers, people with non-technical backgrounds, people with little to no computing expertise, or the like) is becoming increasingly challenging and difficult.

For example, machine generated data encompass a wide range of outputs, such as temperature sensor data, telemetry information regarding battery and CPU usage, lengthy log files detailing application usage and operating system events, and even sensitive biometric data. The sheer volume of machine generated data within one system (e.g., one data processing system) further complicates processing, transfer, and storage of such data, while also raising significant privacy and security concerns, especially when transferring such data to external source (e.g., a cloud based storage). The complexity and diversity of this data, coupled with the need for specialized domain expertise, often render machine generated data inaccessible to a broader audience. This underutilization contributes to the lag in telemetry-based innovations and predictive maintenance solutions. Additionally, the demand for real-time processing, given the volume and complexity adds yet another layer of complexity in the use of machine generated data.

However, the above-discussed computing resources of idle NPUs (also referred to herein as “idle NPU resources”) may advantageously be utilized, using processes and methods associated with embodiments disclosed herein, to resolve this issue concerning machine generated data.

In particular, large language models (LLMs) have shown remarkable efficiency in Natural Language Processing (NLP) tasks including interpreting machine generated data into formats comprehensible to humans. Thus, such idle NPU resources can advantageously be put to more effective use through implementation of a self-reliant, on-device LLM that is fine-tuned on machine generated data. Such a self-reliant, on-device LLM may be configured to process machine generated data at its source (e.g., at the data processing system from which the machine generated data was obtained) and converting such machine generated data into a human readable format (e.g., into human readable data).

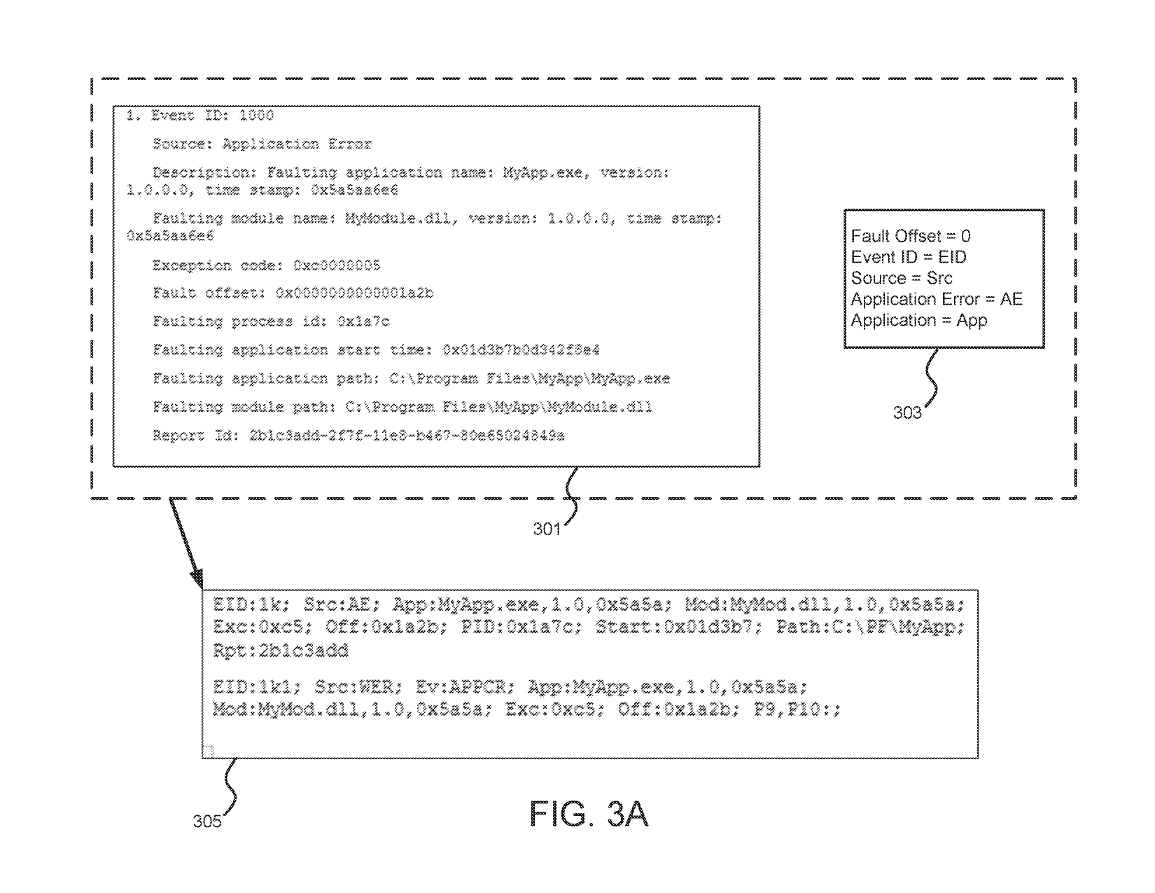

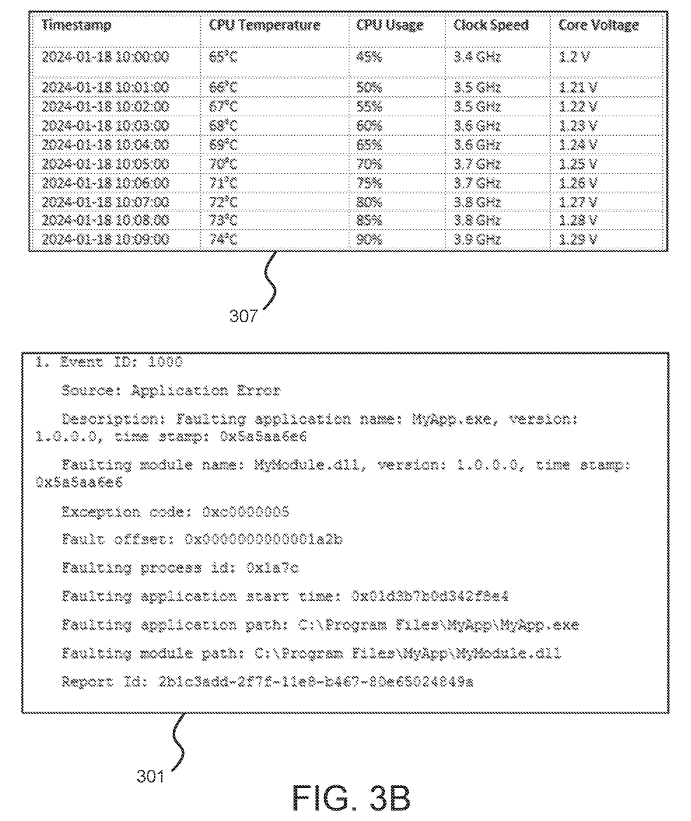

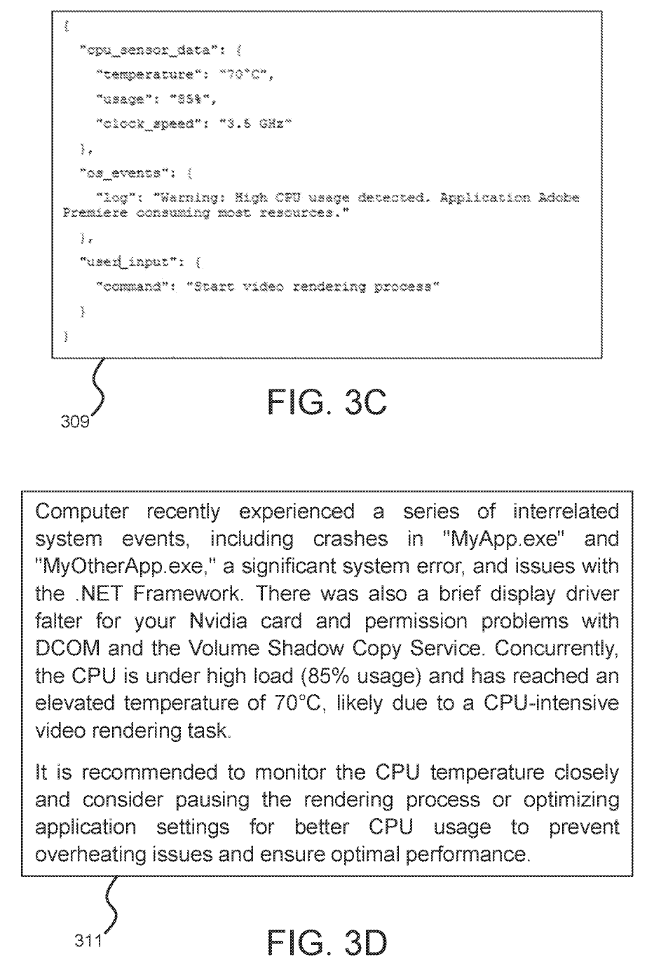

For example, through utilization of embodiments disclosed herein, machine generated data (e.g., telemetry data), which is inherently noisy and disorganized, may fed into one or more trained LLMs that are operating in an idle state in order for these trained LLMs to intelligently extract and organize relevant information tailored for various applications such as predictive maintenance and troubleshooting issues associated with a data processing system. In particular, the trained LLMs may correlate telemetry data with software usage patterns and carry out quantitative analyses leveraging NPU. This transforms raw, unstructured telemetry information into structured, meaningful insights that would be easily understood by users of all technical levels. For example, a clear, human-readable snapshot of actionable telemetry insights may be provided (e.g., by the trained LLMs) when a specific event like a thermal anomaly occurs. Additional details and examples of such clear, human-readable snapshots are presented and discussed below in reference to FIGS. 3A-3D.

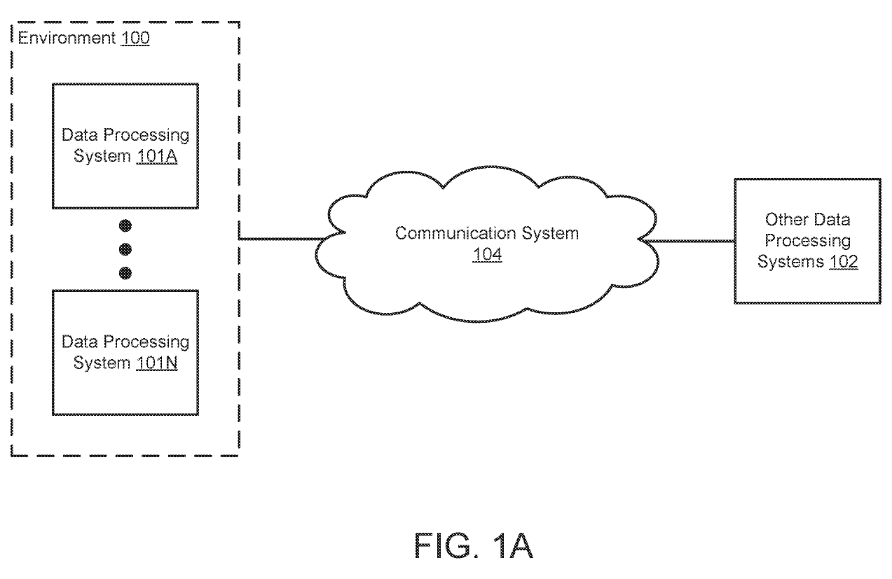

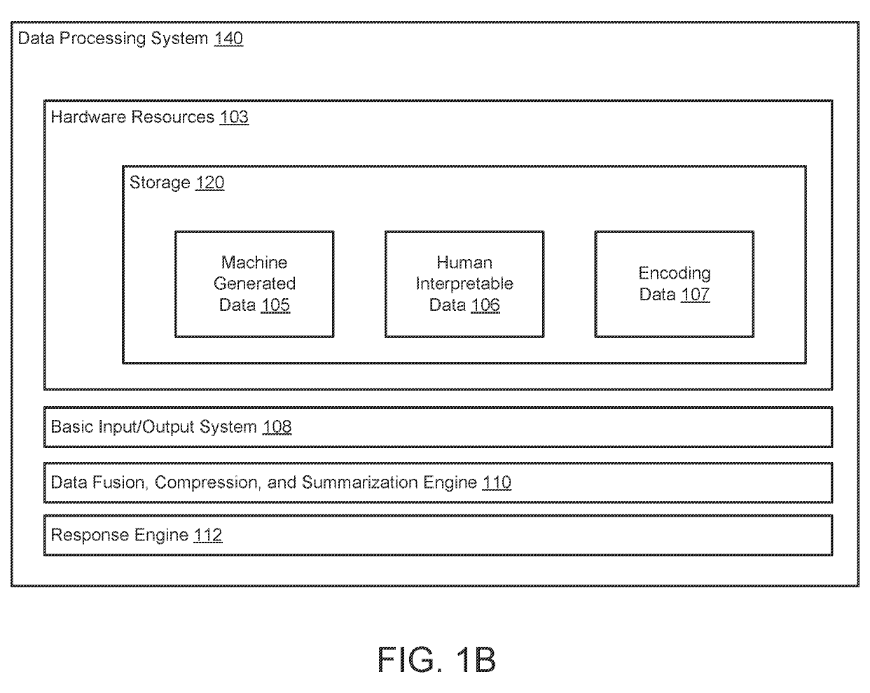

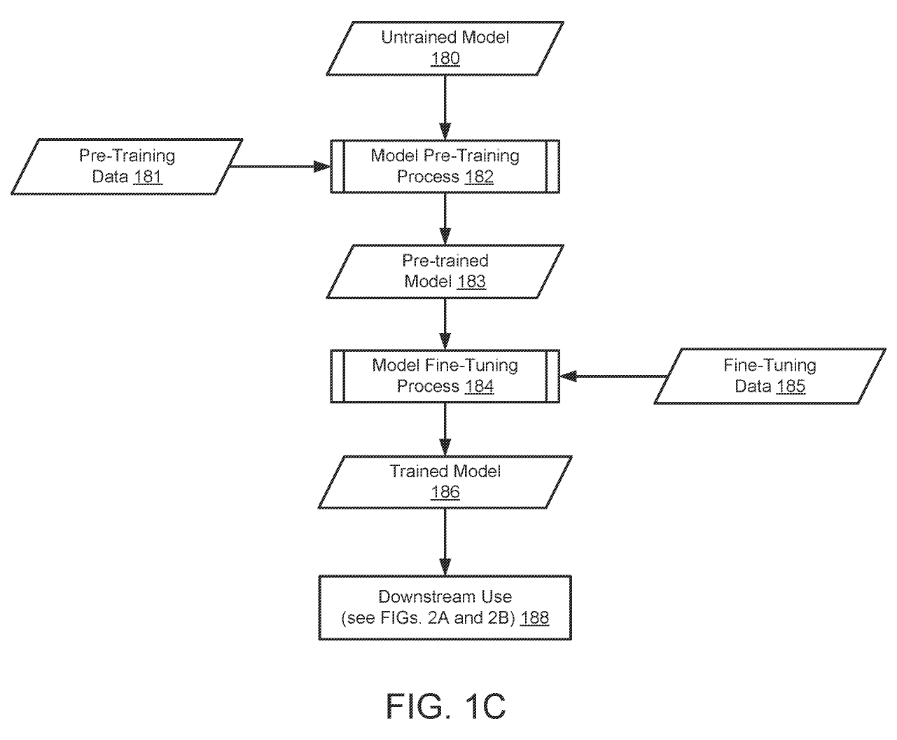

In addition to the conversion of machine generated data into human readable data, the idle NPU resources can also advantageously be used to compress such data. For example, trained LLMs may autonomously refine and prepare telemetry data for online transfer (e.g. for further troubleshooting/validation by a remote/online troubleshooting entity), employing compression to conserve bandwidth and energy. Such compression of the converted machine generated data makes the data more interpretable and cost-effective to store and transmit while preserving the integrity of the insights the data holds. For example, rather than sending all telemetry data collected over the last 7 days to a cloud-based service, the trained LLMs (in their idle operating state) of embodiments herein may extract only useful information and use custom terminology mappings (e.g., the encoding data discussed below in reference to FIGS. 1B-3D) to compress the 7-days’ worth telemetry data into a smaller volume before performing the uploading.

As a result, embodiments disclosed herein may improve computer-related technology (e.g., data analysis related technology, data science-based technology, computer troubleshooting based technology, or the like) by providing machine generated data to users (e.g., any type of users including those with no formal technical training or knowledge that would enable these users to understand machine readable data in its raw format or even slightly translated formatted) in a format and presentation that is easier for these users to access, understand, and interpret. Said another way, unlike traditional deep learning telemetry-based models, often perceived as black boxes, embodiments disclosed herein provide an improved system that ensures clarity and understandability of previously difficult to interpreted and/or previously hidden data by making machine readable data globally accessible, including to general audiences, paving the way for ground-breaking innovation in various fields of computer-based technologies.

Additionally, using the above-discussed compression techniques, machine generated data that would otherwise have been inaccessible to users (e.g., because of the sheer volume/size of the data at the time the data was collected) can now be presented and provided to users in a compressed state. Because the compression results in only a portion of the data being presented, certain sensitive and/or propriety information in the machine generated data (e.g., source code, raw algorithms, or the like) may be shield (e.g., kept secret) from external sources, advantageously ensuring privacy by keeping such sensitive/proprietary portions of the machine generated data at the source while sharing only the important insights and explanations.

Even further, embodiments disclosed herein may directly improve all fields of computing-related technology as a whole. The disadvantages and limits associated with underutilization of machine generated data that contributes to the lag in telemetry-based innovations and predictive maintenance solutions may be overcome and resolved using the processes and methods of embodiments disclosed herein.

Other advantages, improvements to various computer-related technologies and improvements to computer functionalities will be apparent below as more details regarding embodiment disclosed here are described.

In an embodiment, a method may include: converting, by a first trained large language model (LLM) hosted on a data processing system, machine generated data into human readable data. The converting may be performed by: obtaining the machine generated data; converting the machine generated data into human interpretable format data; compressing the human interpretable format data into human interpretable summaries using a set of encoding data, the human interpretable summaries being the human readable data; converting the human interpretable summaries into embeddings; and storing, by the first trained LLM, the embeddings into a vector database. The method may further include: using, by a second trained LLM and in response to one or more event triggers, the human interpretable summaries to generate one or more prompts for a user of the data processing system.

The first trained LLM performs the converting of the machine generated data into the human readable data using idle neural processing unit (NPU) resources, the idle NPU resources are associated with at least one NPU of the data processing unit, the at least one NPU is separate from a central processing unit (CPU) of the data processing system.

The second trained LLM is different from the first trained LLM.

The set of encoding data comprises abbreviations for one or more terms appearing in the human interpretable format data, the abbreviations comprising a combination of standard abbreviations and non-standard abbreviations for the one or more terms.

Multiple instances of the machine generated data are fused, by the first trained LLM, into the human interpretable format data, the multiple instances of the machine generated data being fused based on at least one cause-and-effect relationship between two data points within the multiple instances of the machine generated data identified by the first trained LLM.

The one or more event triggers comprise at least a query submitted by the user to the second trained LLM regarding an operating state of the data processing system.

The second trained LLM is a multi-modal Retrieval Augmentation Generation (RAG) architecture based LLM.

The one or more event triggers further comprise a failure or potential failure of one or more operations of the data processing system, and the one or more prompts being presented to the user by the second trained LLM as a warning for the failure or potential failure of the one or more operations.

Prior to the converting of the machine generated data into human readable data, the method further include training the first trained LLM by: obtaining an untrained LLM; pre-training, during a first training stage of the first trained LLM, the untrained LLM using a set of pre-training data comprising raw machine generated data to obtain a pre-trained LLM, the raw machine generated data being non-human-annotated data and is used to expand a vocabulary of the untrained LLM; and training, during a second training stage of the first trained LLM, the pre-trained LLM using an LLM fine-tuning data to fine-tune the pre-trained LLM and obtain the first trained LLM.

The fine-tuning data comprises: custom embedding training data used during unsupervised training of the pre-trained LLM, and human-annotated data used to fine-tune the pre-trained LLM while training the LLM to become capable of converting the machine generated data into human interpretable format data and compressing the human interpretable format data into the human interpretable summaries.

A non-transitory media may include instructions that when executed by at least a processor of a data processing system cause the computer-implemented method to be performed by the data processing system.

A data processing system may include the non-transitory media and a processor, and may perform the computer-implemented method when processor executes the instructions in the non-transitory media.

Turning to FIG. 1A, a block diagram illustrating a system in accordance with an embodiment is shown. The system shown in FIG. 1A may provide computer implemented services. The computer implemented services may include any type and quantity of computer implemented services. For example, the computer implemented services may include data storage services, instant messaging services, database services, AI services and/or any other type of service that may be implemented with a computing device.

To provide the above noted functionality, the system of FIG. 1A may include any number of data processing systems 101A-101N that make up a computing environment 100. Computing environment 100 may be any type of environment (e.g., a deployment, a remote server, a corporation’s office, a single user, or the like) where one or more of the data processing systems 101A-101N may be hosted and used to provide computer implemented services to one or more users.

Each data processing system 101A-101N may be a node within the computing environment 100. One or more nodes may then be combined and/or arranged into one or more clusters (e.g., one or more groups of data processing systems), each of which having at least one of the nodes. Additionally, data processing systems 101A-101N may provide the computer implemented services to users of data processing systems 101A-101N and/or to other devices (not shown). Different data processing systems may provide similar and/or different computer implemented services.

To provide the computer implemented services, data processing systems 101A-101N may include various hardware components (e.g., various types of processors, memory modules, storage devices, etc.) and host various software components (e.g., operating systems, application, machine learning model, startup managers such as basic input-output systems, etc.). These hardware and software components (discussed in more detail below in FIG. 1B) may provide the computer implemented services via their operation.

The software components may be implemented using various types of services. For example, each data processing system of the data processing systems 101A-101N may host various services that provide the computer implemented service (e.g., application services, data anonymization services, data verification services, or the like) and/or that manage the operation of these services (e.g., management services). The aggregate (e.g., combination) of the management and application services may be a complete service that provide desired functionalities.

Any of the components illustrated in FIG. 1A may be operably connected to each other (and/or components not illustrated) with communication system 104. In an embodiment, communication system 104 includes one or more networks that facilitate communication between any number of components (e.g., computing environment 100 with other data processing systems 102 making up other environments over the network). The networks may include wired networks and/or wireless networks (e.g., and/or the Internet). The networks may operate in accordance with any number and types of communication protocols (e.g., such as the Internet Protocol).

In embodiments, within the computing environment 100, the data processing systems 101A-101N may be connected via a local area network (LAN) based protocol to form an intranet setting between the data processing systems 101A-101N.

While FIG. 1A is illustrated as including a limited number of specific components, a system in accordance with an embodiment may include fewer, additional, and/or different components than those illustrated therein.

Turning to FIG. 1B, a diagram illustrating data processing system 140 in accordance with an embodiment is shown. Data processing system 140 may be similar to any of the data processing systems 101A-101N and/or any of the other data processing systems 102 shown in FIG. 1A.

To provide computer implemented services (e.g., machine generated data conversion services, data compression services, services associated with any of the processes and/or methods discussed below in refernce to FIGS. 1C-3D, or the like), data processing system 140 may include any quantity of hardware resources 103. Hardware resources 103 may include physical parts of data processing system 140 that store and run software. Hardware resources 103 may include processors (e.g., CPUs, GPUs, NPUs), memory modules (also referred to herein as “memory devices”), storage devices, and/or other types of hardware components usable to provide computer implemented services. A basic input/output system (BIOS) 108 may be stored on the processors and memory modules.

Storage 120 may be implemented using any combination of storage devices (e.g., hard disk drives (HDDs), solid state drives (SSDs), volatile memory, non-volatile memory, or the like). Storage 120 may be configured to store machine generated data 105, human interpretable data 106, and one or more sets of encoding data 107.

In embodiments, machine generated data 105 may include any type of data that can be gathered from the components (e.g., both software and hardware components) making data processing system 140. For example, machine generated data may include, but is not limited to: temperature sensor data, telemetry information regarding battery and CPU usage, lengthy log files detailing application usage and operating system events, sensitive biometric data for logging into and/or powering on the data processing system and/or accessing one or more applications or components of the data processing system, or the like. Examples of machine generated data 105 are shown below in reference to FIGS. 3A-3D

In embodiments, the one or more sets of encoding data 107 may be a processed form of the machine generated data 105. More specifically, human interpretable data 106 may be a form of the machine generated data 105 that has been processed to be more easily accessible and understandable by technical and/or non-technical users of the data processing system 140. The human interpretable data 106 may be stored in summarized and/or non-summarized forms. In summarized form, the human interpretable data 106 may be referred to herein as “human-interpretable summaries”. In non-summarized form, the human interpretable data 106 may be referred to herein as “human-interpretable format data”. Examples of human interpretable data 106 are shown below in reference to FIGS. 3A-3D.

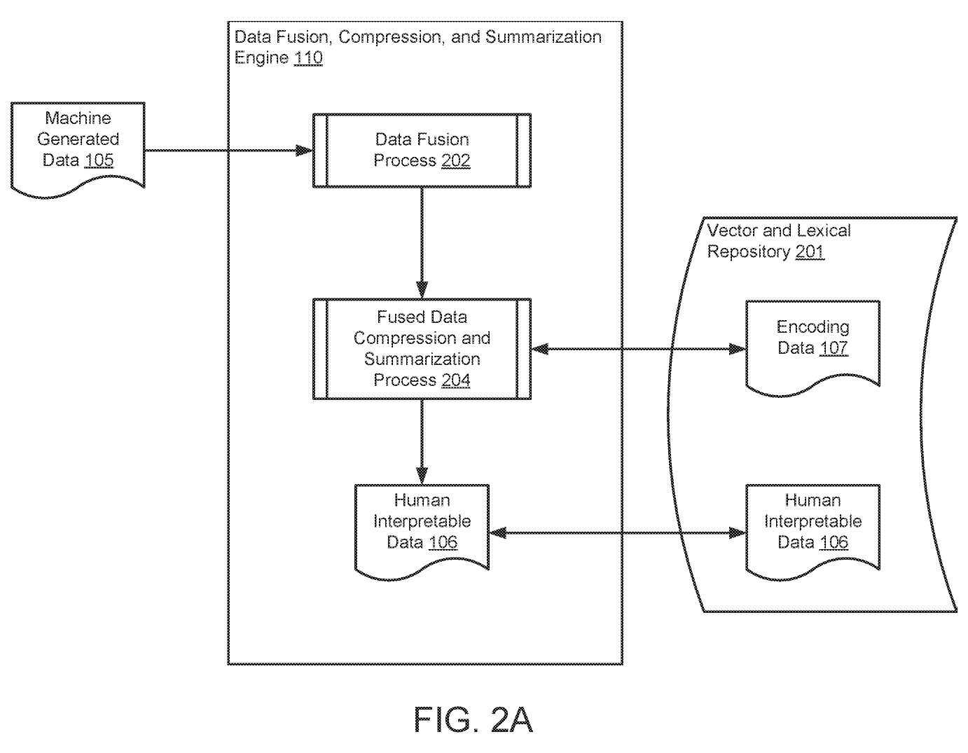

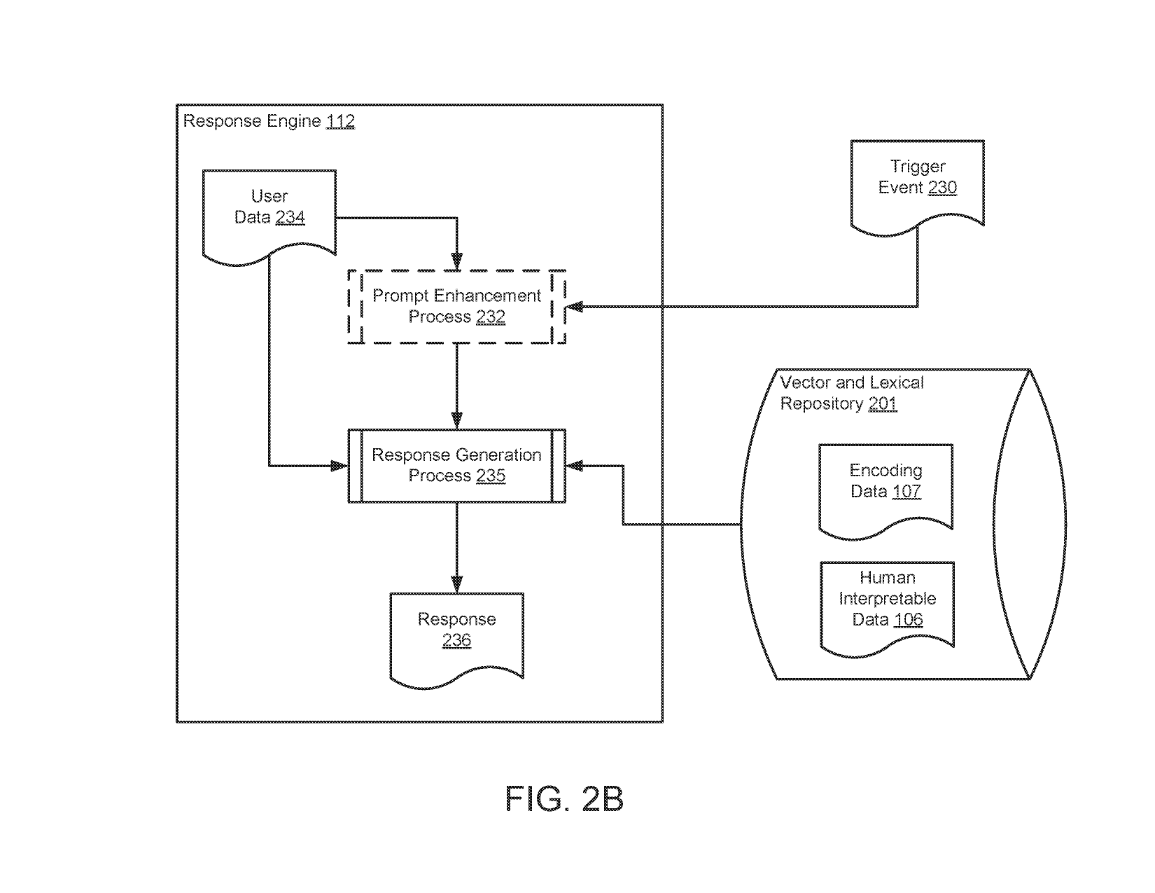

In embodiments, the one or more sets of encoding data 107 may include unique terms and/or abbreviations that utilizes custom terminology mappings inspired by sparse priming representations. The one or more sets of encoding data 107 may be used to summarize and/or compress the human-interpretable format data version of the human interpretable data 106. The one or more sets of encoding data 107 may be provided by one or more users of the data processing system 140 and/or may be created by any of the trained LLMs discussed below in reference to FIGS. 1C and 2A. Examples of the one or more sets of encoding data 107 are shown below in reference to FIGS. 3A-3D.

BIOS 108 may be used to startup data processing system 140. On the startup, BIOS 108 may configure peripheral devices, such as a keyboard, mouse, monitor, etc. With the peripheral devices, BIOS 108 may configure hardware resources 103 for use by data processing system 140. Any data associated with the operating condition of the data processing system 140 that can be gathered from BIOS 108 may also be stored as machine generated data 105.

Data fusion, compression, and summarization engine 110 may be implemented using hardware, software, or a combination thereof. For example, data fusion, compression, and summarization engine 110 may be configured using and/or configured to host a large language model (LLM). The LLM may be hosted on an NPU making up the hardware resources 103 of the data processing system 140. The LLM may be specifically configured (e.g., instantiated and trained) as a machine generated data conversion LLM that converts (e.g., transforms) the machine generated data 105 into one or more forms of the human interpretable data 106 (e.g., while using the encoding data 107). Functions and training of the machine generated data conversion LLM are discussed in more detail below in reference to FIGS. 1C and 2A.

Response engine 112 may be implemented using hardware, software, or a combination thereof. For example, response engine 112 may be configured using another LLM (referred to herein as a “response LLM”) hosted on the NPU that is different from the machine generated data conversion LLM of the data fusion, compression, and summarization engine 110. The response LLM may be trained using any known methods and techniques associated with AI chat bot based LLM training (e.g., semantics type training, multi-modal Retrieval Augmentation Generation (RAG) architecture-based training, or the like). The response LLM may be configured to interact with one or more users of the data processing system 140 and present one or more responses (e.g., prompts) to these users based on one or more trigger events (e.g., based on receiving a question from a user; based on chatting with a user; based on one or more events of the data processing system 140 including failure events, timed events, scheduled, events, or the like; or the like). Additional details regarding the functions of the response LLM are discussed below in reference to FIG. 2B.

In embodiments, the human interpretable data 106 may be generated on-device within a single data processing system 140 and/or within multiple data processing systems 140 connected via an intranet environment without utilizing any remote network resources (e.g., a remote server on the network, or the like). The on-device human interpretable data 106 generation may be performed when the NPUs of the data processing system(s) 140 are indicated (e.g., via a status label, via a work queue of the NPU(s), or the like) to be idle. Said another way, the NPUs are determined (e.g., by the data processing system 140) to be idle when the data processing system 140 assess that there is nothing for the NPU to do within a predetermined period of time (e.g., 30 minutes, 1 hour, etc.) and/or if a status of an NPU indicates that it is currently idle.

Once an NPU is determined to be idle (or even partially idle with some NPU resources being labeled as idle while other NPU resources of the same NPU are executing other AI tasks), the resources of these idle NPUs (or partially idle NPUs) may be configured by the data processing system 140 (e.g., via instructions/commands from the CPU, the NPU’s independent processor core, or the like) to start performing machine generated data conversion to start (e.g., essentially as a background process of the NPUs) replacing one or more of machine generated data 105 with the human interpretable data 106. This advantageously utilizes idle NPU resources that would have otherwise went to waste as the NPUs sit idle and also directly improves the functionalities of the data processing system by freeing up memory space in the storage 120 through the replacement of machine generated data 105 with the human interpretable data 106 (namely, since human interpretable data 106 uses significantly less storage space (e.g., limited storage resources of storage 120) than the machine generated data 105. This directly improves the functionality of data processing system 140 by freeing up limited storage resources of storage 120 that would otherwise have been wasted on storing less accessible/less useful (to a non-technical user or the like) machine generated data 105.

Further, since NPUs are specifically designed for AI tasks and are more cumbersome (or even simply not designed) to be used for non-AI tasks (e.g., graphics processing similar to GPUs and operating system management similar to CPUs), ensuring that none of the NPUs become idle or stay in the idle state for too long advantageously provides a more effective/efficient use of these NPUs.

Additionally, the on-device machine generated data conversion process (e.g., via a single computing device or within an intranet setting) advantageously avoids any negative impacts (e.g., delays resulting from network latency, data loss, or the like) associated with transmission of data over a network (e.g., transmitting the non-anonymized data 105 to a remote network server for anonymization and then receiving the anonymized data 106 back from the remote network server). Furthermore, the approach of using idle NPU resources also advantageously leverages energy-efficient processing based on cycle harvesting techniques.

While FIG. 1B is illustrated as including a limited number of specific components, a data processing system in accordance with an embodiment may include fewer, additional, and/or different components than those illustrated therein. For example, in addition to all of the components shown in FIG. 1B, the data processing system 140 may also include part of all of the components of the example computing device described below in refernce to FIG. 5.

Turning now to FIG. 1C, FIG. 1C shows a data flow diagram illustrating a process for instantiating and training the machine generated data conversion LLM of the data fusion, compression, and summarization engine 110. In the data flow diagram of FIG. 1C, components and data (e.g., trained or untrained models, time-series data, or the like) are shown using a first set of shapes (e.g., 180, 181, 183, 185, 186, etc.), processes using the data and/or components are shown using a second set of shapes (e.g., 182, 184), and uses of the data and/or components are shown using a third set of shapes (e.g., 188).

As shown in FIG. 1C, an untrained model 180 may first be obtained. The untrained model 180 may be a LLM that has not yet been configured (e.g., trained) for any specific tasks and/or has been minimally configured (e.g., with the necessary libraries, etc.) to perform a specific function (namely, in the context of embodiments disclosed herein, the untrained model 180 may be minimally configured for data conversion functionalities).

In embodiments, the untrained model 180 may be obtained from any source without departing from the scope of embodiments disclosed herein. In one example, the untrained model 180 may be created by the entity associated with environment 100 (e.g., of FIG. 1A) using propriety code or using open-source code. In another example, the untrained model 180 may be downloaded from the network (e.g., the Internet) from one or more online developer’s website (e.g., in the form of an LLM template/base LLM model).

The untrained model 180 may be ingested into model pre-training process 182 along with pre-training data 181. As part of model pre-training process 182 any suitable LLM-based pre-training techniques may be applied to the untrained model 180 without departing from the scope of embodiments disclosed herein. The pre-training data 181 may include a diverse array of machine generated data including, but not limited to: raw sensor data, telemetry (e.g., of data processing system 140), event logs/system logs, application logs, or the like. The main purpose of this model pre-training process 182 is to expand the untrained model 180’s vocabulary and tokens, thereby equipping the untrained model 180 with the capacity to understand and process a wide range of machine generated data format and types.

Unlike existing training protocols where untrained models are trained on web text corpora with mostly user-generated content, such pre-training using (e.g., raw) machine generated data advantageously enables the untrained model 180 to obtain a deeper and more detailed understanding of machine generated data of different format and types. This is an improvement over conventional/traditional model pre-training processes in that the resulting pre-trained model 183 generated from model pre-training processes would be more easily adaptable to real-world application and environments where data is unstructured and not pre-treated/processed (e.g., less synthetic and more natural than) like the traditional user-generated content used in model-pretraining.

Once the pre-trained model 183 is obtained, the pre-trained model is ingested into model fine-tuning process 184 to be fine-tuned (e.g., further trained) using fine-tuning data 185. In particular, fine-tuning data 185 may include human-annotated data that helps the pre-trained model 183 more accurately identify the most relevant and important information (e.g., critical alerts, errors, warnings, key events, etc.) from within the machine generated data while also filtering out any sensitive, proprietary information from within the machine generated data. Said another way, the model fine-tuning processes 184 utilizes the fine-tuning data 185 to help the pre-trained model 183 understand and present the machine generated data in a standard interpretable format. The standard interpretable format may be based on one or more nationally and/or globally used data presentation formats. Alternatively, the standard interpretable format may be based on an entity’s (e.g., the entity that owns data processing system 140 and/or environment 100) own protocols and requirements.

As further part of the model fine-tuning process 184, the pre-trained model 183 may be configured to utilize system timestamps to group related data segments (e.g., within the machine generated data) and arrive at cause-and-effect decisions (e.g., cause-and-effect relationships) between one or more of the machine generated data before then converting this information into the standard interpretable format. For example, the model being fine-tuned may be trained to extract instances where CPU temperature of the data processing system 140 exceeds average thresholds and associate this event with software usage patterns of the data processing system (e.g., if application A and B are both running simultaneously and the CPU overheats, an alert can be composed to advise a user of data processing system 140 to consider shutting down one of the two applications if one is not in use). This fine-tuning advantageously ensures that the machine generated data conversion LLM (e.g., the eventually obtained trained model 186) can identify and emphasize critical information within the complex data and represent it in a normalized manner.

As even further part of the model fine-tuning process 184, the pre-trained model 183 may be further fine-tuned (e.g., trained) to compress the standard interpretable format data using encoding data (e.g., 107, FIG. 1C) that is also included in fine-tuning data 185. Such compression may be performed while carefully retaining key information for efficiency and brevity to transform the human-interpretable format data (i.e., the non-summarized form of the human interpretable data 106) into the human-interpretable summaries (i.e., the summarized form of the human interpretable data 106). Such human-interpretable summaries (examples of which are shown in refernce to FIGS. 3A-3B) may highlight key events and trends within the standard interpretable format generated from (e.g., fused using) various instances the machine generated data.

As yet an even further part of the model fine-tuning process 184, the human-annotated data included in the fine-tuning data 185 may be used to train the pre-trained model 183 to implement a custom embedding model architecture that enables the eventual trained model 186 to convert the human-interpretable summaries into embeddings (e.g., vectors) that capture the critical semantics of the original machine generated data. This advantageously ensures that complex machine generated data is reduced to a statically dimensioned vectors without losing essential telemetry data semantics.

Other LLM training techniques/protocols not discussed above that achieve the same effects/results may also be used as part of any of the model pre-training process 182 and model fine-tuning process 184 without departing from the scope of embodiments disclosed herein.

Once fine-tuned, a trained model 186 (e.g., a trained machine generated data conversion LLM) may be obtained. Once the trained model 186 is obtained, the trained model 186 may (as discussed above) be applied to one or more downstream uses (e.g., used in the machine generated data conversion processes of embodiments disclosed herein). Such downstream uses are further discussed below in refernce to FIGS. 2A-3D.

In embodiments, the model training process shown in FIG. 1C may be performed by the data processing system 140 hosting the data fusion, compression, and summarization engine 110. Alternatively, the model training process shown in FIG. 1C may be performed may be performed by a separate computing device (e.g., any other data processing system) with the trained model 186 then being provided (e.g., transmitted) to be hosted by the data processing system 140 using the data fusion, compression, and summarization engine 110 (e.g., as a dynamically updated mirror copy of the trained model 186 that is continuously updated and further refined on the separate data processing system). For example, each time the trained model 186 is updated on the separate computing device, the data processing system 140 hosting the data fusion, compression, and summarization engine 110 will also receive (e.g., as a mirror copy) the updated version of the trained model 186. In embodiments, any of the model trainings steps discussed in FIG. 1C may be performed using supervised learning techniques, unsupervised learning techniques, or a combination thereof.

In embodiments, the machine generated data conversion LLM and the response LMM may be configured using a single LLM. In this example, the model training process may also encompass, as part of the model fine-tuning process 184 (and/or as a second stage model fine-tuning process) any model training processes required to further train the machine generated data conversion LLM to include the functionalities of the response LLM (e.g., to further train the include machine generated data conversion LMM to include a multi-modal Retrieval Augmentation Generation (RAG) architecture and corresponding functionalities). Such multi-modal Retrieval Augmentation Generation (RAG) architecture may enable the response LLM (and/or the combination of the two LLMs) to be fine-tuned for query (e.g., user query, or the like) optimization to maximize data retrieval accuracy and relevance. The RAG architecture may support diverse machine generate data-based use cases, such as conversational interfaces with telemetry data to predictive maintenance, leveraging efficiently stored interpretable and compressed data (e.g., leveraging the human interpretable data 106).

To further clarify embodiments disclosed herein, data flow diagrams in accordance with embodiments disclosed herein are shown in FIGS. 2A and 2B. In these data flow diagrams of FIGS. 2A and 2B, flows of data and processing of data are illustrated using different sets of shapes. A first set of shapes (e.g., 105, 106, 107, etc.) is used to represent data structures (e.g., files, documents, data packets, or the like), a second set of shapes (e.g., 202, 204, 206, etc.) is used to represent processes performed using and/or that generate data, a third set of shapes (e.g., 110, etc.) is used to components and/or devices that perform (e.g., execute) the processes shown using the second set of shapes, and a fourth set of shapes (e.g., 201) is used to represent large scale data structures such as databases that can be instantiated and stored in, e.g., storage 120 of data processing system 140 (see, e.g., FIG. 1B).

Starting with FIG. 2A, FIG. 2A shows processes performed by the machine generated data conversion LLM of the data fusion, compression, and summarization engine 110. In particular, FIG. 2A shows how the machine generated data conversion LLM coverts (e.g., transforms) machine generated data 105 into human interpretable data 106.

As shown in FIG. 2A, machine generated data 105 is obtained by the machine generated data conversion LLM of the data fusion, compression, and summarization engine 110. The machine generated data 105, which may include machine generated data collected over any period of time (e.g., a few seconds, a few minutes, a few hours, a few days, or the like), is ingested into data fusion process 202.

Returning to FIG. 2A, as part of data fusion process 202, and as discussed above in reference to FIG. 1C, the machine generated data conversion LLM may identify the most relevant and important information (e.g., critical alerts, errors, warnings, key events, etc.) from within the machine generated data while also filtering out any sensitive, proprietary information from within the machine generated data. The machine generated data conversion LLM may then utilize system timestamps to group related data segments (e.g., within the machine generated data) and arrive at cause-and-effect decisions between one or more of the machine generated data before then converting this information into the standard interpretable format. Said another way, various instances of the machine generated data may be fused (e.g., based on the cause-and-effect decisions, or the like) into the standard interpretable format. At the end of data fusion process 202, the instance(s) of the obtained machine generated data are transformed into human interpretable data 106 (namely, the in the human interpretable format data form).

For example, the model being fine-tuned may be trained to extract instances where CPU temperature of the data processing system 140 exceeds average thresholds and associate (e.g., fuse) this event with software usage patterns of the data processing system (e.g., if application A and B are both running simultaneously and the CPU overheats, an alert can be composed to advise a user of data processing system 140 to consider shutting down one of the two applications if one is not in use). An example of a fusing of two sets of machine generated data is shown below in refernce to FIGS. 3B-3D.

Once the standard interpretable format data (e.g., the fused data) is obtained, the fused data may be ingested into fused data compression and summarization process 204 where the fused data is transformed into human interpretable data 106 (namely, the in the human interpretable summaries form).

In particular, and as discussed above in reference to FIG. 1C, the machine generated data conversion LLM may summarize the standard interpretable format data (e.g., the fused data) to highlight key events and trends identified within the fused data. More specifically, a set of encoding data 107 that includes custom encodings and/or characters that represent key events/data (e.g., the phrase “Event ID” may be encoded/represented as EID, or BSOD with a special Unicode character) may be used to compress and summarize the fused data.

In embodiments, such custom encodings and/or characters included in the set of encoding data 107 can later be decoded (e.g., decompressed and/or interpreted) by a separate LLM that receives the human interpretable data 106 from the machine generated data conversion LLM. For example, the encoding data 107 may be provided to the separate LLM to use as a guide and/or index for the decoding. Examples of the human interpretable data 106 (namely, the in the human interpretable summaries form) are shown below in refernce to FIGS. 3A and 3C.

In embodiments, the human interpretable data 106 generated from fused data compression and summarization process 204 may be stored into a vector and lexical repository 201. This vector and lexical repository 201 may be a database instantiated within storage 120 of data processing system 140 of FIG. 1B. Prior to being stored into the vector and lexical repository 201, the human interpretable data 106 may be (as discussed above in reference to FIG. 1C) converted (e.g., transformed) into embeddings (e.g., vectors). The embeddings may be stored within a vector database created within vector and lexical repository 201 where similar vectors may be grouped together based on a semantic grouping format (e.g., a group of vectors related to “CPU data” may be grouped together, or the like). Other methods and/or techniques for storing vectors within a vector database may also be utilized without departing form the scope of embodiments disclosed herein.

Encoding data 107 may also be stored in vector and lexical repository 201. In embodiments, encoding data 107 may continuously be updated by machine generated data conversion LLM as the machine generated data conversion LLM continues to learn and evolve. For example, a first (e.g., original) copy of the encoding data 107 may only include encodings defined (e.g., provided) by a user/entity associated with (e.g., managing) data processing system 140. However, as the machine generated data conversion LLM continues to learn and evolve the machine generated data conversion LLM may come up with (e.g., generate, create, or the like) its own encodings/characters and update the encoding data 107 with these new encodings/characters.

In embodiments, to manage storage of the human interpretable data 106 in vector and lexical repository 201, a data retention policy may be implemented. The data retention policy may follow any format and may include any type of rules for the retention of the human interpretable data 106 within vector and lexical repository 201. For example, the data retention policy may specify that any instance of the human interpretable data 106 may only be stored for a maximum of, e.g., 12 months before they are overwritten with newly stored copies of the human interpretable data 106.

Turning now to FIG. 2B, FIG. 2B shows processes performed by the response LMM of the response engine 112. In particular, FIG. 2B shows how the response LMM utilizes the human interpretable data 106 and the encoding data 107 stored in vector and lexical repository 201 to provide one or more users of the data processing system 140 with a human readable version of the machine generated data.

As shown in FIG. 2B, the response LMM may obtain a trigger event 230. The trigger event 230 may be any form of input or event that may trigger the response LMM to provide the user with an explanation of what is going on with data processing system 140.

For example, in one instance, the trigger event 230 may be a user query/inquiry that is input (e.g., submitted) into a graphical user interface (GUI) (e.g., an AI chatbot interface, or the like) associated with the response LLM. More specifically, the user query/input may be obtained a result of the user being interested in/curious about a current operating state of the data processing system 140 and/or about an adverse event that occurred to the data processing system 140. For example, the user may enter a query of “why is my computer so hot?” or “tell me about the system’s battery performance.”

As another example, in a different instance, an adverse event (and/or an event or a combination of events that are predefined as a trigger event such as, but not limited to, detection of CPU temperature exceeding certain pre-set thresholds or the like) may have just occurred. For example, the data processing system 140 may have crashed and displayed a Blue Screen of Death (BSOD). Upon restart of the data processing system 140, the response LLM of the response engine 112 may proactively generate a response/prompt (e.g., response 236) based on stored human interpretable data 106 to explain to the user why the BSOD may have occurred.

In embodiments, the trigger even 230 may be ingested into an optional prompt enhancement process 232 along with user data 234. The user data 234 may contain any type of information (e.g., user preferences, previous requests, or the like) associated with a current and/or detected user of the data processing system 140. The user data 234 may be used to tailor the response 236 to be more suitable for the current and/or detected user (e.g., the user’s technical skill level, ranking within a corporation, or the like may be used to customize the response 236 to best fit the user).

The optional prompt enhancement process 232 may be used to enhance, in the event that the trigger event 230 is a user query/inquiry, the wording of the user query/inquiry. For example, assume that the user is not a very technically savvy individual. In this situation, the user may not be able to accurately convey what the user wants to know to the response LLM. The optional prompt enhancement process 232 may utilize the user data 234 (and other types of data and factors) to enhance the user query/inquiry to a point where the response LLM will be able to generate a response 236 that fits the user’s needs. Any type of prompt enhancement techniques may be used as part of optional prompt enhancement process 232 without departing from the scope of embodiments disclosed herein.

In embodiments, the original trigger event 230 and/or the enhanced version of the trigger event 230 (e.g., enhanced using prompt enhancement process 232) may be ingested into response generation process 235 along with the user data 234. As part of the response generation process 235, the response LMM may utilize its multi-modal RAG architecture to generate a response 236 (that is responsive to the trigger event 230) using the encoding data 107 and the human interpretable data 106 stored in vector and lexical repository 201.

For example, as part of the response generation process 235, the response LLM may retrieve (e.g., from vector and lexical repository 201) the most relevant human interpretable data 106 corresponding to the trigger event 230. For instance, a trigger even 230 like a user query along the lines of “how is my battery performance” would result in the retrieval of human interpretable data 106 related to battery performance from the vector and lexical repository 201 (along with the associated encoding data 107 for decoding the human interpretable data 106). These retrieved human interpretable data 106, chronologically ordered and timestamped, may then be used by the response LLM to derive a cohesive, human-interpretable narration or data analysis (with LLM’s coding ability), including visual plots as required by the user.

Additionally, information included in the trigger event 230 may also be transformed, by the response LLM, into embeddings such that the response LLM may use these embeddings to find the most similar/identical embeddings (e.g., corresponding to the human interpretable data 106) already stored within vector and lexical repository 201.

Once generated, the response 236 may be provided (e.g., displayed) to the user of the data processing system 140. Using the processes discussed in FIGS. 2A and 2B, embodiments disclosed herein advantageously demystify complex machine generated data, making such complex machine generated data more accessible and usable to a wider range of non-experts. Said another way, by training LLMs to narrate and compile stories or texts in natural language and enhancing these with the data analysis and interpretation abilities of LLMs, complex machine generated data (which are usually abstract) can advantageously be transformed into insightful narratives that could range from summarizing battery performance over a specified period to conversing with telemetry data, or even compiling a comprehensive, human-interpretable story from data indicating recent failures, such as a BSOD issue.

Any of the processes illustrated using the second set of shapes (shown in FIGS. 2A and 2B) may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and fourth set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning now to FIGS. 3A-3D, these figures show implementation examples of embodiments disclosed herein. Starting with FIG. 3A, a portion of machine generated data 301 is shown. This portion of machine generated data 301 may be part of the systems logs/event logs of the data processing system 140 of FIG. 1B. As also shown in FIG. 3A is an example set of encoding data 303. The example set of encoding data 303 includes one or more encodings (e.g., in the form of standard and/or non-standard abbreviations) for one or more terms (e.g., Event ID) appearing in the portion of machine generated data 301.

The combination of the portion of machine generated data 301 and the example set of encoding data 303 may be utilized (e.g., as part of data fusion process 202 and fused data compression and summarization process 204) to obtain example human interpretable data 305 (e.g., shown in the human interpretable summaries form). In this form, the example human interpretable data 305 may only be interpretable (e.g., understandable) by a user with a certain degree of understanding of computing terminology and knowledge. This form of the example human interpretable data 305 may be transformed by the response LLM into a response (e.g., 236) where the contents of example human interpretable data 305 are translated into a more user-friendly narrative in prose (e.g., natural language) form.

Turning now to FIG. 3B, the same portion of machine generated data 301 may be obtained with a second portion of machine generated data 307. The second portion of machine generated data 307 may include time-stamped CPU performance data of the data processing system 140.

As shown in FIG. 3C, the portion of machine generated data 301 and the second portion of machine generated data 307 (along with a different set of encoding data) may be fused and compressed (e.g., as part of data fusion process 202 and fused data compression and summarization process 204) by the machine generated data conversion LLM into second human interpretable data 309. This second human interpretable data 309 may then be further transformed by response LLM into example response 311, as shown in FIG. 3D. Example response 311 may then be presented to a user of data processing system in response to one or more trigger events that caused the generation of example response 311.

Additionally, although idle NPU resources are specifically mentioned herein, embodiments disclosed herein are not limited to the use of these idle resources. More specifically, non-idle resources of NPUs (and/or even idle and/or non-idle resources of CPUs and GPUs of the data processing system) may also be used without departing from the scope of this invention. Other types of processing units (e.g., data processing units (DPUs), language processing unit (LPU), tensor processing units (TPUs), or the like) may also be used to execute the processes and methods of embodiments discussed herein.

Furthermore, although LLMs are specifically mentioned throughout this disclosure, one having ordinary skill in the art would appreciate that any other types of generative AI models (e.g., multi-modal models that handle text, images, and videos; generative adversarial networks (GANs); or the like) may also be used instead of LLMs without departing from the scope of embodiments disclosed herein.

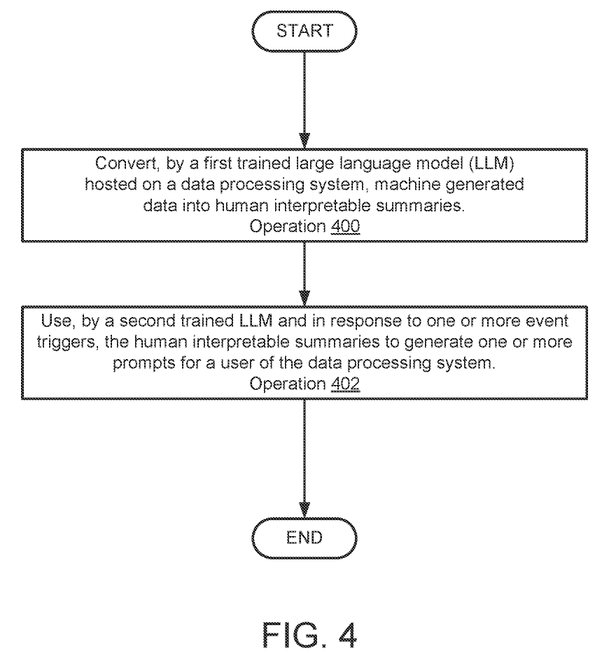

As discussed above, the components of FIGS. 1A-2B may perform various methods for machine generated data conversion using an on-device idle NPU resource utilization process. FIG. 4 illustrates an example of a method that may be performed by the components of FIGS. 1A-2B. For example, any of the data processing systems 101A-101N may perform all or a portion of the methods. In the diagrams discussed below and shown in FIG. 4, any of the operations may be repeated, performed in different orders, and/or performed in parallel with or in a partially overlapping in time manner with other operations. Additionally, the process depicted in the flowchart of FIG. 4 may be performed using idle NPU resources of one or more NPU(s) hosted by a data processing system.

Starting at Operation 400 of FIG. 4, as discussed above in reference to FIGS. 1C-2B, a first trained LLM (e.g., the machine generated data conversion LLM) may be used to convert machine into one or more human interpretable summaries (e.g., human interpretable data 106 of FIGS. 1B-2B).

In embodiments, these human interpretable data 106 may be stored in the data processing system 140 to replace corresponding machine generated data that was used to generate these human interpretable data 106.

At Operation 402, and as discussed above in reference to FIGS. 2A-2B, human interpretable data 106 stored in the data processing system 140 may be used by a second trained LLM (e.g., the response LLM) to generate one or more prompts (e.g., response 236 of FIG. 2B) for a user of the data processing system.

In embodiments, the generation of the one or more prompts may be based on one or more event triggers obtained (e.g., received, detected, or the like) by the second trained LLM. The one or more event triggers may comprise a failure or potential failure of one or more operations of the data processing system, and the one or more prompts may be presented to the user by the second trained LLM as a warning for the failure or potential failure of the one or more operation. The one or more prompts generated by the second trained LLM may be provided (e.g., displayed) to the user.

The process of FIG. 4 may end following Operation 402.

Although embodiments disclosed herein have been described using a local, on-device/intranet setting, they are not limited to such a configuration. Namely, embodiments disclosed herein may also be applied to a network setting where idle NPU resources are shared (e.g., rented, sold, used in cooperatively, or the like) between data processing systems of different environments (e.g., 100, FIG. 1A) separated by the network (e.g., communication system 104 of FIG. 1A). For example, the idle NPU resources of data processing systems 101A-101N of environment 100 may be shared (e.g., rented out, shared with, used cooperatively with, sold to, etc.) with any of the other data processing systems 102 that are separated from environment 100 by communication system 104. Said another way, the idle NPU resources of environment 100 may be provided to the other data processing system 102 in an as-a-service (aaS) manner, similar to a digital idle NPU resource marketplace setting.

Any of the components illustrated in FIGS. 1A-4 may be implemented with one or more computing devices. Turning to FIG. 5, a block diagram illustrating an example of a computing device (also referred to herein as “system 500”) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high-level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system-on-a-chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth® transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method comprising:
converting, by a first trained large language model (LLM) hosted on a data processing system, machine generated data into human readable data by:
obtaining the machine generated data;
converting the machine generated data into human interpretable format data;
compressing the human interpretable format data into human interpretable summaries using a set of encoding data, the human interpretable summaries being the human readable data;
converting the human interpretable summaries into embeddings; and
storing, by the first trained LLM, the embeddings into a vector database; and
using, by a second trained LLM and in response to one or more event triggers, the human interpretable summaries to generate one or more prompts for a user of the data processing system.

2. The method of claim 1, wherein the first trained LLM performs the converting of the machine generated data into the human readable data using idle neural processing unit (NPU) resources, the idle NPU resources are associated with at least one NPU of the data processing system, the at least one NPU is separate from a central processing unit (CPU) of the data processing system.

3. The method of claim 2, wherein the second trained LLM is different from the first trained LLM.

4. The method of claim 3, wherein the set of encoding data comprises abbreviations for one or more terms appearing in the human interpretable format data, the abbreviations comprising a combination of standard abbreviations and non-standard abbreviations for the one or more terms.

5. The method of claim 4, wherein multiple instances of the machine generated data are fused, by the first trained LLM, into the human interpretable format data, the multiple instances of the machine generated data being fused based on at least one cause-and-effect relationship between two data points within the multiple instances of the machine generated data identified by the first trained LLM.

6. The method of claim 2, wherein the one or more event triggers comprise at least a query submitted by the user to the second trained LLM regarding an operating state of the data processing system.

7. The method of claim 6, wherein the second trained LLM is a multi-modal Retrieval Augmentation Generation (RAG) architecture based LLM.

8. The method of claim 7, wherein the one or more event triggers further comprise a failure or potential failure of one or more operations of the data processing system, and the one or more prompts being presented to the user by the second trained LLM as a warning for the failure or potential failure of the one or more operations.

9. The method of claim 1, wherein prior to the converting of the machine generated data into human readable data, the method further comprises training the first trained LLM by:
obtaining an untrained LLM;
pre-training, during a first training stage of the first trained LLM, the untrained LLM using a set of pre-training data comprising raw machine generated data to obtain a pre-trained LLM, the raw machine generated data being non-human-annotated data and is used to expand a vocabulary of the untrained LLM; and
training, during a second training stage of the first trained LLM, the pre-trained LLM using an LLM fine-tuning data to fine-tune the pre-trained LLM and obtain the first trained LLM.

10. The method of claim 9, wherein the fine-tuning data comprises:
custom embedding training data used during unsupervised training of the pre-trained LLM, and
human-annotated data used to fine-tune the pre-trained LLM while training the LLM to become capable of converting the machine generated data into human interpretable format data and compressing the human interpretable format data into the human interpretable summaries.

11. A non-transitory machine-readable medium having instructions stored therein, which when executed by a processor, cause the processor to perform operations comprising:
converting, by a first trained large language model (LLM) hosted on a data processing system, machine generated data into human readable data by:
obtaining the machine generated data;
converting the machine generated data into human interpretable format data;
compressing the human interpretable format data into human interpretable summaries using a set of encoding data, the human interpretable summaries being the human readable data;
converting the human interpretable summaries into embeddings; and
storing, by the first trained LLM, the embeddings into a vector database; and
using, by a second trained LLM and in response to one or more event triggers, the human interpretable summaries to generate one or more prompts for a user of the data processing system.

12. The non-transitory machine-readable medium of claim 11, wherein the first trained LLM performs the converting of the machine generated data into the human readable data using idle neural processing unit (NPU) resources, the idle NPU resources are associated with at least one NPU of the data processing system, the at least one NPU is separate from a central processing unit (CPU) of the data processing system.

13. The non-transitory machine-readable medium of claim 12, wherein the second trained LLM is different from the first trained LLM.

14. The non-transitory machine-readable medium of claim 13, wherein the set of encoding data comprises abbreviations for one or more terms appearing in the human interpretable format data, the abbreviations comprising a combination of standard abbreviations and non-standard abbreviations for the one or more terms.

15. The non-transitory machine-readable medium of claim 14, wherein multiple instances of the machine generated data are fused, by the first trained LLM, into the human interpretable format data, the multiple instances of the machine generated data being fused based on at least one cause-and-effect relationship between two data points within the multiple instances of the machine generated data identified by the first trained LLM.

16. A data processing system comprising:
a central processing unit (CPU); and
a memory coupled to the CPU to store instructions, which when executed by the CPU, cause the CPU to perform operations comprising:
converting, by a first trained large language model (LLM) hosted on a data processing system, machine generated data into human readable data by:
obtaining the machine generated data;
converting the machine generated data into human interpretable format data;
compressing the human interpretable format data into human interpretable summaries using a set of encoding data, the human interpretable summaries being the human readable data;
converting the human interpretable summaries into embeddings; and
storing, by the first trained LLM, the embeddings into a vector database; and
using, by a second trained LLM and in response to one or more event triggers, the human interpretable summaries to generate one or more prompts for a user of the data processing system.

17. The data processing system of claim 16, wherein the first trained LLM performs the converting of the machine generated data into the human readable data using idle neural processing unit (NPU) resources, the idle NPU resources are associated with at least one NPU of the data processing system, the at least one NPU is separate from the CPU of the data processing system.

18. The data processing system of claim 17, wherein the second trained LLM is different from the first trained LLM.

19. The data processing system of claim 18, wherein the set of encoding data comprises abbreviations for one or more terms appearing in the human interpretable format data, the abbreviations comprising a combination of standard abbreviations and non-standard abbreviations for the one or more terms.

20. The data processing system of claim 19, wherein multiple instances of the machine generated data are fused, by the first trained LLM, into the human interpretable format data, the multiple instances of the machine generated data being fused based on at least one cause-and-effect relationship between two data points within the multiple instances of the machine generated data identified by the first trained LLM.
